(19) United States
(12) Patent Application Publication
(10) Pub. No.: US 2019/0197052 A1
(43) Pub. Date: Jun. 27, 2019

(54) PICTURE-RELATED INFORMATION DISPLAY DEVICE, MULTIFUNCTION PERIPHERAL, AND PICTURE-RELATED INFORMATION DISPLAY METHOD

(71) Applicant: SHARP KABUSHIKI KAISHA, Sakai City (JP)

(72) Inventor: TAKESHI OKAMOTO, Sakai City (JP)

(21) Appl. No.: 16/228,142

(22) Filed: Dec. 20, 2018

(30) Foreign Application Priority Data
Dec. 26, 2017 (JP) 2017-249338

(51) Int. Cl. G06F 16/587; G06F 16/29; G06F 16/54; H04N 1/00

(52) U.S. Cl. CPC G06F 16/587; G06F 16/29; H04N 2201/0094; H04N 1/00411; H04N 1/00472; G06F 16/54

(57) ABSTRACT

A picture-related information display device includes a position mark display unit that displays, on a map, a position mark corresponding to one or more pictures determined to be in a single geographical range in accordance with a predetermined standard for a positional relationship; and a picture list display unit that, upon the position mark having been selected, displays a list of the one or more pictures corresponding to the position mark.

### BACKGROUND

### 1. Field

The present disclosure relates to picture-related information display devices, multifunction peripherals, and picture-related information display methods.

### 2. Description of the Related Art

To date, there exists a technique for indicating a spot on a map on the basis of GPS information embedded in a picture. As disclosed in Japanese Unexamined Patent Application Publication No. 2007-322847, there also exists a technique for loading image data having information on its shooting location and its shooting date and time and displaying image data captured on a specified date and time onto a position corresponding to its shooting location on a map.

However, there is no standard as to the extent of a range that is regarded as a single spot for display, and an issue arises in that it takes time to narrow down to or search for a desired picture when browsing through images. Japanese Unexamined Patent Application Publication No. 2014-13600 discloses a technique that allows a search range of images to be adjusted, but this technique merely allows for a fine adjustment of a geographical range.

It is desirable to provide a picture-related information display device, a multifunction peripheral, and a picture-related information display method that allow a user to select the extent of a range that is regarded as a single spot for display.

### SUMMARY

According to an aspect of the present disclosure, there is provided a picture-related information display device that includes a position mark display unit that displays, on a map, a position mark corresponding to one or more pictures determined to be in a single geographical range in accordance with a predetermined standard for a positional relationship; and a picture list display unit that, upon the position mark having been selected, displays a list of the one or more pictures corresponding to the position mark.

According to another aspect of the present disclosure, there is provided a picture-related information display device that includes a position mark display unit that displays, on a map, a position mark corresponding to one or more pictures determined to be in a single geographical range in accordance with a predetermined standard for a positional relationship; and a number list display unit that, upon the position mark having been selected, displays a name of each geographical range of a plurality of geographical ranges that are lower by one level than the geographical range corresponding to the position mark and the number of pictures of which shooting spots are in the geographical range.

According to yet another aspect of the present disclosure, there is provided a multifunction peripheral that includes the above picture-related information display device.

According to yet another aspect of the present disclosure, there is provided a program that causes a computer to function as the above picture-related information display device.

According to yet another aspect of the present disclosure, there is provided a picture-related information display method that includes displaying, on a map, a position mark corresponding to one or more pictures determined to be in a single geographical range in accordance with a predetermined standard for a positional relationship; and displaying, upon the position mark having been selected, a list of the one or more pictures corresponding to the position mark.

### BRIEF DESCRIPTION OF THE DRAWINGS

FIG. 1 illustrates a screen displayed by a picture-related information display device according to a first embodiment of the present disclosure;

FIG. 2 illustrates another screen displayed by the picture-related information display device according to the first embodiment of the present disclosure;

FIG. 3 illustrates yet another screen displayed by the picture-related information display device according to the first embodiment of the present disclosure;

FIG. 4 illustrates yet another screen displayed by the picture-related information display device according to the first embodiment of the present disclosure;

FIG. 5 illustrates yet another screen displayed by the picture-related information display device according to the first embodiment of the present disclosure;

FIG. 6 illustrates yet another screen displayed by the picture-related information display device according to the first embodiment of the present disclosure;

FIG. 7 illustrates yet another screen displayed by the picture-related information display device according to the first embodiment of the present disclosure;

FIG. 8 illustrates yet another screen displayed by the picture-related information display device according to the first embodiment of the present disclosure;

FIG. 9 illustrates yet another screen displayed by the picture-related information display device according to the first embodiment of the present disclosure;

FIG. 10 illustrates a screen displayed by a picture-related information display device according to a second embodiment of the present disclosure;

FIG. 11 illustrates a screen displayed by a picture-related information display device according to a third embodiment of the present disclosure;

FIG. 12 illustrates a screen displayed by a picture-related information display device according to a fourth embodiment of the present disclosure;

FIG. 13 illustrates another screen displayed by the picture-related information display device according to the fourth embodiment of the present disclosure;

FIG. 14 illustrates a screen displayed by a picture-related information display device according to a fifth embodiment of the present disclosure;

FIG. 15 is a conceptual sectional view of a multifunction peripheral according to a common embodiment of the present disclosure; and

FIG. 16 is a functional block diagram of the multifunction peripheral according to the common embodiment of the present disclosure.

### DESCRIPTION OF THE EMBODIMENTS

Hereinafter, embodiments for implementing the present disclosure will be described in detail with reference to the drawings.

### First Embodiment

Additional information can be appended, for example, to picture data in JPEG format. To picture data captured by a camera equipped with a GPS function, additional information that expresses the shooting position detected by the GPS function by the latitude and the longitude is appended. In addition, the address of the shooting position can be detected on the basis of the latitude and the longitude of the shooting position and map information, and additional information that expresses the shooting position by the address is appended to the picture data.

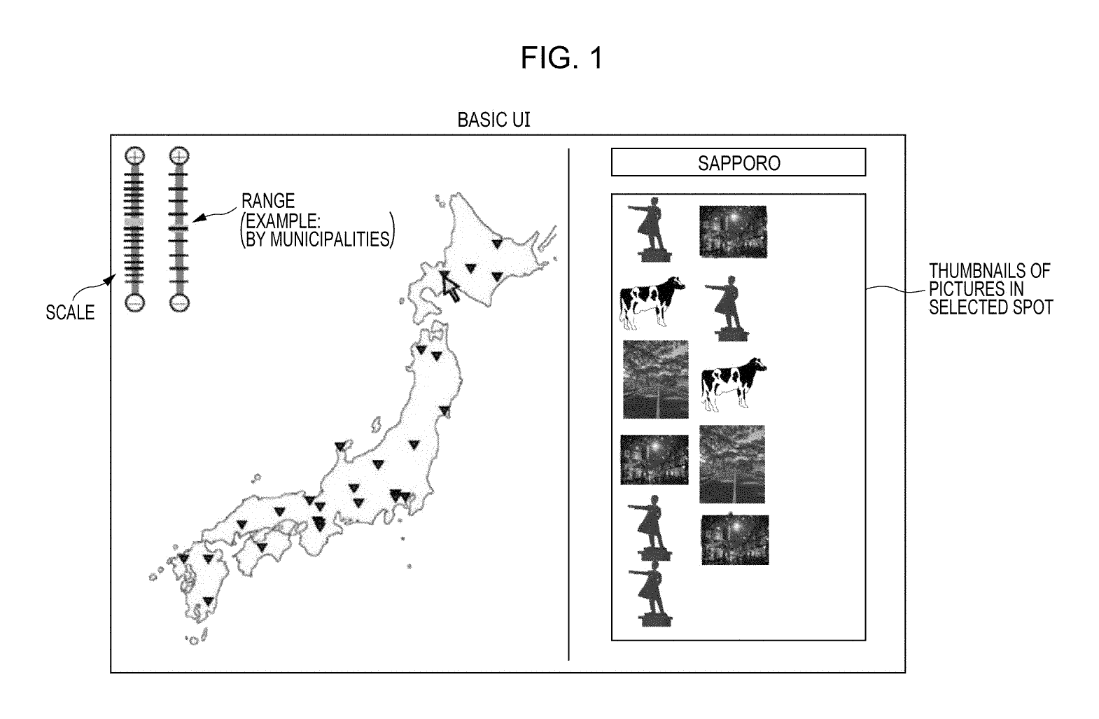

In a first embodiment, as illustrated in FIG. 1, a map and a mark ▾ indicating a shooting position are displayed in a left screen. In addition, a list of thumbnails of pictures is displayed in a right screen.

A scale slider for adjusting the scale and a range slider for adjusting a range for a single group of shooting positions are also displayed in the left screen.

When the scale slider is moved upward, the map is enlarged. When the scale slider is moved downward, the map is reduced.

When the range slider is moved upward, the range for a single group of shooting positions is narrowed. When the range slider is moved downward, the range for a single group of shooting positions is broadened. Specifically, as the position of the range slider moves upward from the bottom, the range for a single group of shooting positions varies from a single country to a single region, a single prefecture, a single municipality, and a pinpoint spot.

In an initial screen, for example, a map of Japan having its scale adjusted to allow the entire country to be displayed is displayed in the left screen, and the scale slider is at a position corresponding to that scale. On this map of Japan, the shooting positions of all the pictures that can be displayed by this display device are displayed. However, it is not that the shooting positions of the individual pictures are displayed, but the shooting positions are displayed by the municipalities selected as an initial value for the single group of shooting positions. Therefore, no mark ▾ indicating the shooting position is displayed for a municipality with no picture data to be displayed, and a mark ▾ indicating the shooting position is displayed for a municipality with one or more pieces of picture data.

In addition, thumbnails of pictures in an area of the group selected in the initial state are displayed in a list form in the right screen. In the example illustrated in FIG. 1, Sapporo is selected in the initial state, and thus thumbnails of pictures captured in Sapporo are displayed in a list form in the right screen.

One of the marks ▾ can be selected through a user operation. Upon a certain mark ▾ having been selected, thumbnails of pictures of which the shooting positions are in an area corresponding to the selected mark are displayed in a list form in the right screen. For example, if the mark ▾ indicating Nara is selected, thumbnails of pictures of which the shooting positions are in Nara are displayed in a list form in the right screen.

As already described above, the range for a single group of shooting positions can be modified by moving the range slider up and down. While the range for a single group of shooting position is a municipality and the selected group is Sapporo as illustrated in FIG. 1, moving the range slider downward causes the range for a single group of shooting positions to change to Hokkaido, which includes Sapporo. Along with this, the list of pictures displayed in thumbnails in the right half of the screen changes from the list of pictures of which the shooting positions are included in Sapporo to a list of pictures of which the shooting positions are included in Hokkaido. Therefore, if there is a picture of which the shooting position is included in Obihiro, for example, the picture of which the shooting position is included in Obihiro is added to the list.

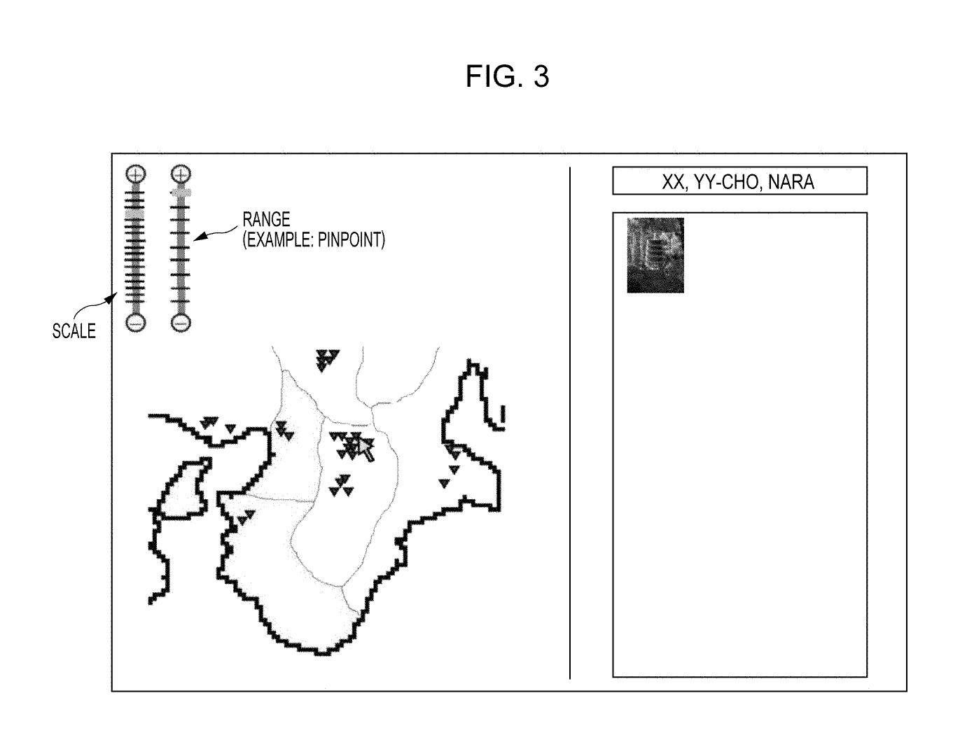

When a pinpoint is specified as a single group of shooting positions by the range slider as illustrated in FIG. 3, with a predetermined margin of error taken into consideration, pictures determined to have shooting positions different from the specified pinpoint are displayed individually in thumbnails or in a normal format, and a plurality of pictures determined to have the same shooting position are displayed in a thumbnail list form.

In the foregoing, a display method that does not take the shooting date and the shooting time into consideration in particular has been described. Alternatively, only pictures captured in a specified year, in a specified month of a specified year, on a specified date, or in a predetermined time period on a specified date may, for example, be displayed.

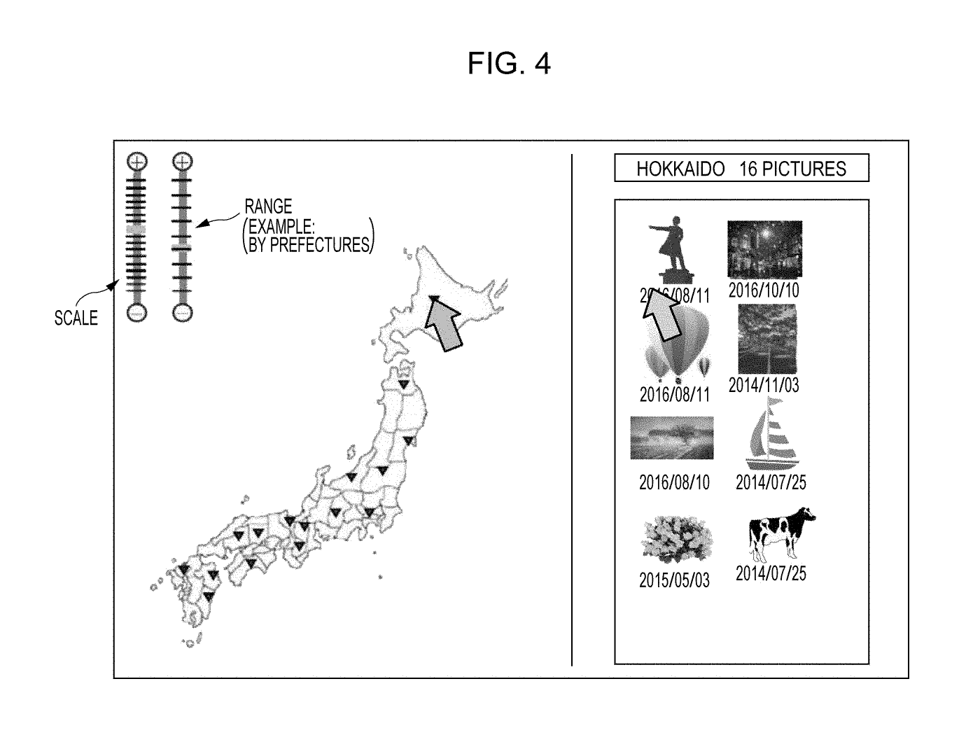

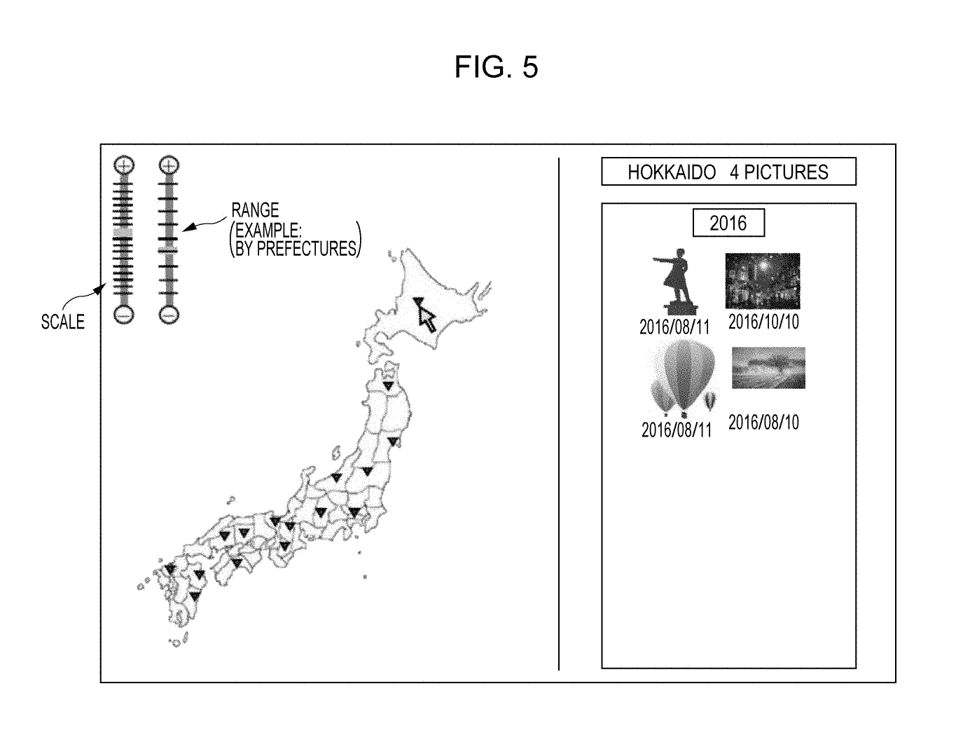

For example, when the shooting dates of pictures #1, #2, #3, #4, #5, #6, #7, and #8 narrowed down to as display targets upon Hokkaido having been specified as the positional range while no date or time is specified by the year, the month, the day, or the like are Aug. 11, 2016, Oct. 10, 2016, Aug. 11, 2016, Nov. 3, 2014, Aug. 10, 2016, Jul. 25, 2014, May 3, 2015, and Jul. 25, 2014, respectively, as illustrated in FIG. 4, if the year 2016 is specified as the date range, the display targets are narrowed down to the four pictures #1, #2, #3, and #5, as illustrated in FIG. 5.

In the foregoing, a display method that allows only one positional range to be specified has been described. Alternatively, a plurality of positional ranges may be allowed to be selected.

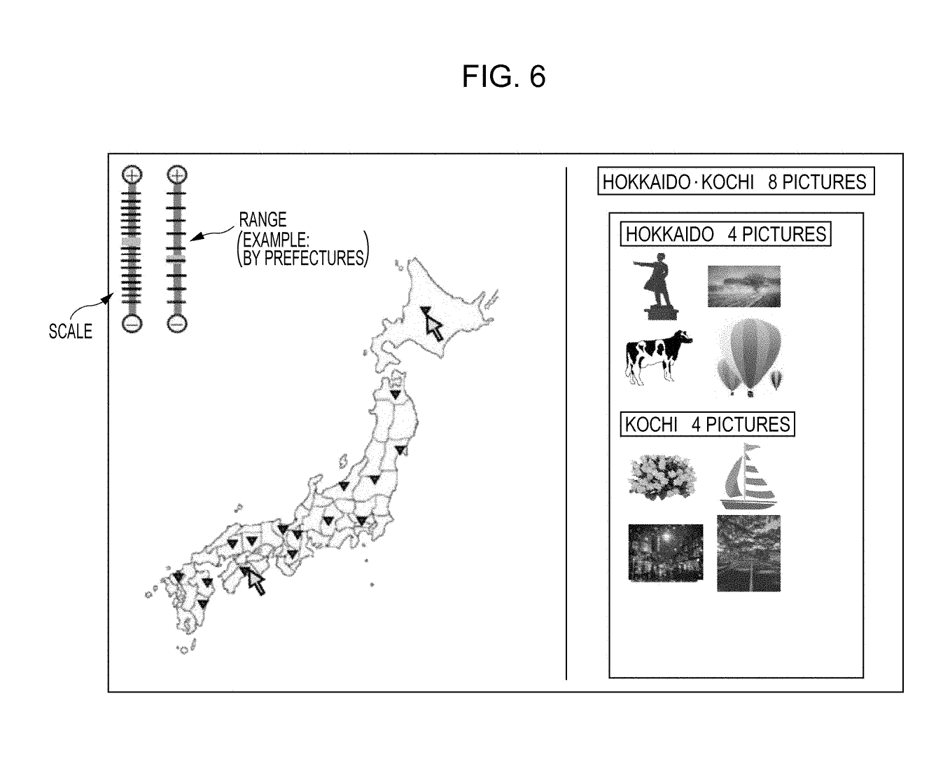

For example, as illustrated in FIG. 5, while Hokkaido is being specified as the positional range, the year 2016 is being specified as the date range, and the display targets are being narrowed down to the four pictures through the above specifications, when Kochi Prefecture is additionally specified as the positional range, the four pictures captured in Kochi Prefecture in 2016 are added, as illustrated in FIG. 6.

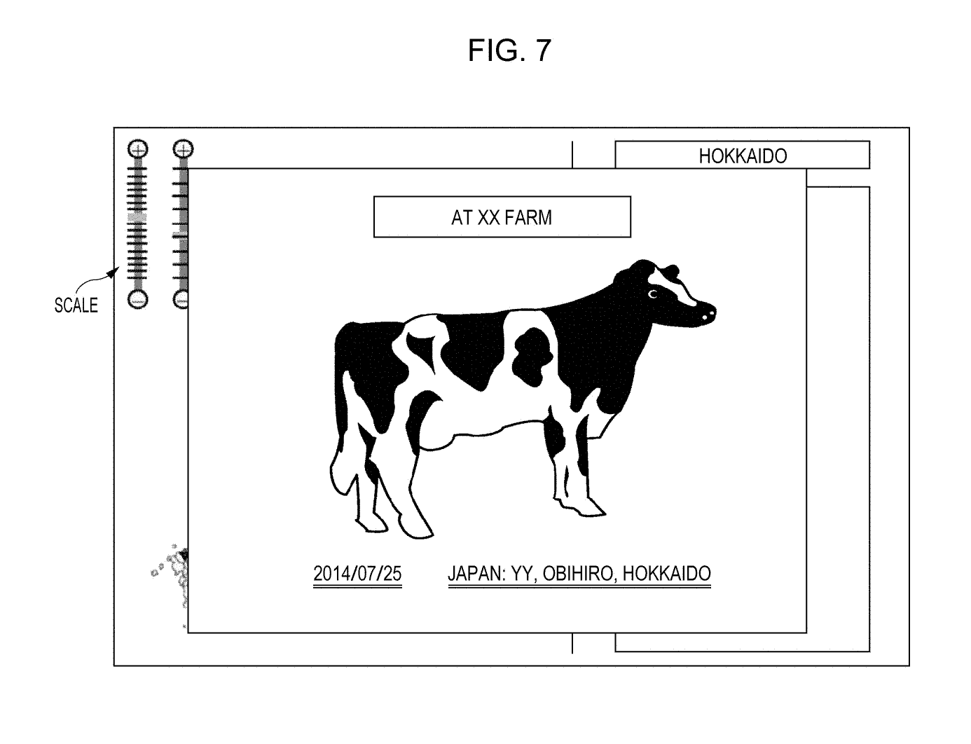

In the foregoing, only an example in which the pictures are displayed in thumbnails has been described. Alternatively, upon a picture displayed in a thumbnail in a list having been selected, the picture may be displayed in a normal format with the additional information, as illustrated in FIG. 7. Examples of the additional information include the shooting date and time, the shooting location, and the title. For the shooting location, the name of the area may be displayed, the latitude and the longitude may be displayed, or all of the above may be displayed.

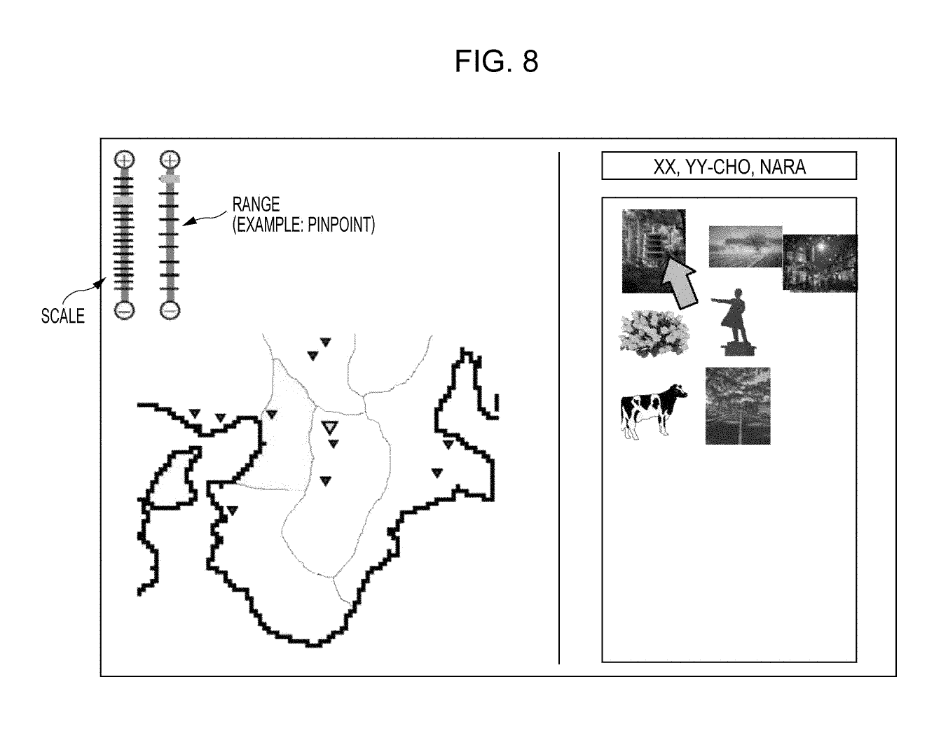

In addition, as already described above, when the pictures are displayed by municipalities, no mark ▾ indicating a shooting position is displayed for a municipality with no picture data to be displayed, and a mark ▾ indicating a shooting position is displayed for a municipality with one or more pieces of picture data. In accordance with the above, for example, a thumbnail list of pictures is displayed with the pictures grouped by a municipality in the right screen. Here, upon any one of the thumbnails having been selected by the user, the mark ▾ indicating the municipality including the shooting location of that thumbnail may be highlighted in the left screen. For example, the color of the mark ▾ may be made different from a normal color, or the mark ▾ may be blinked or enlarged. This allows the user to check the municipality where the picture has been captured on the map. FIG. 8 illustrates an example in which the mark ▾ indicating Nara in the left screen is being highlighted as the thumbnail of the picture captured in XX, YY, Nara has been selected.

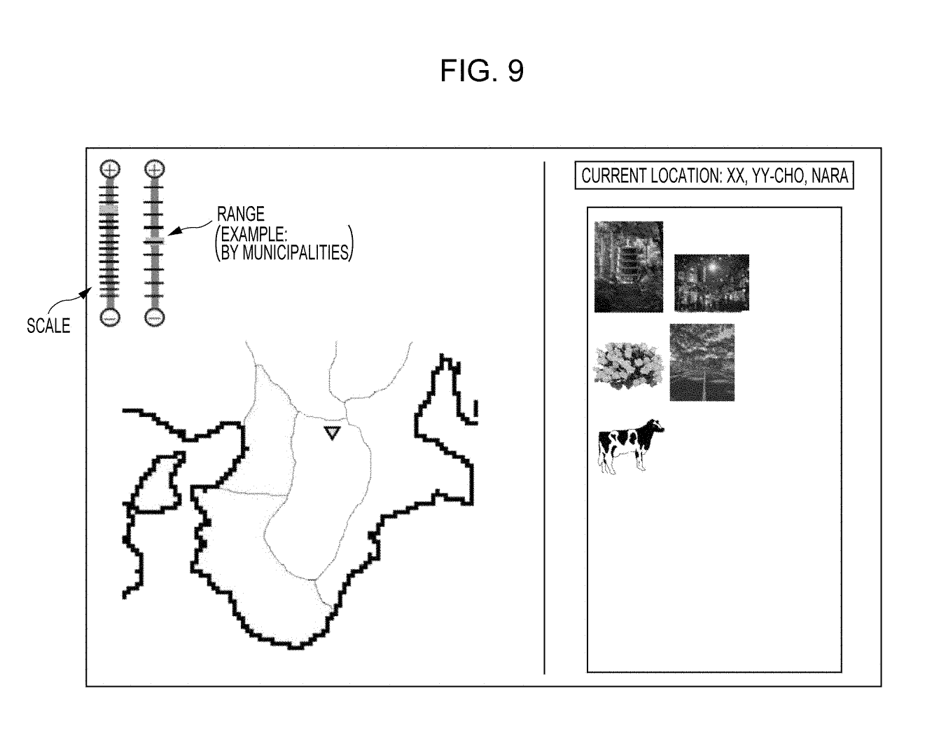

When a terminal that allows its position to be detected with a GPS function or the like is used, as illustrated in FIG. 9, the detected position of the terminal may be displayed on the map in the left screen, thumbnails of pictures of which the shooting positions include the position of the terminal and the vicinity thereof may be displayed in a list form.

### Second Embodiment

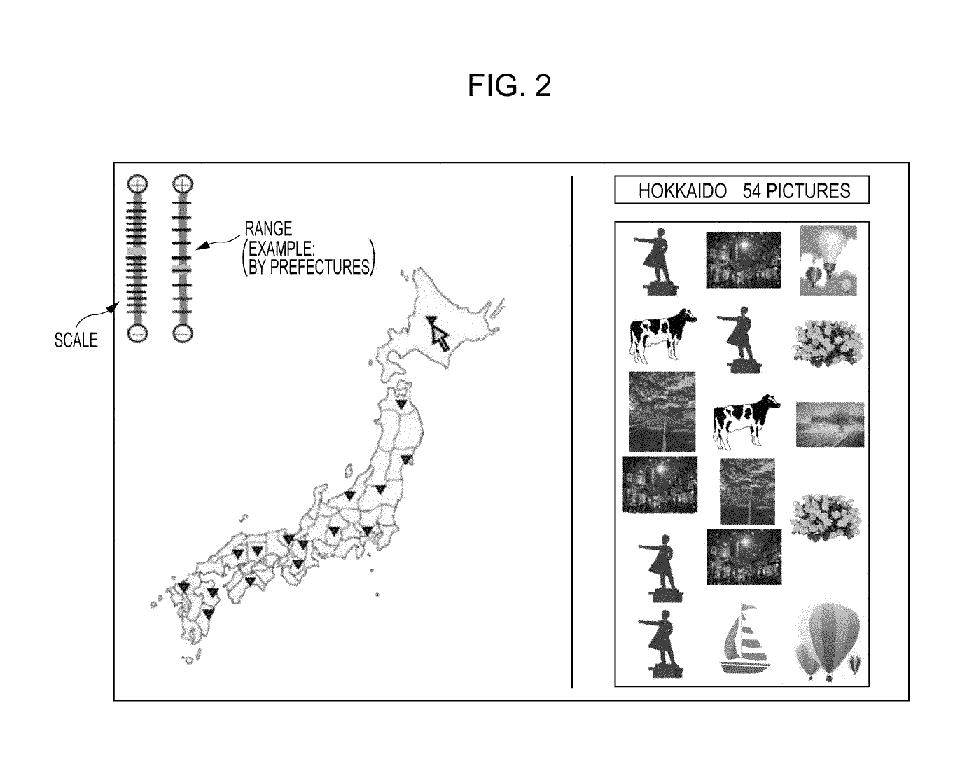

In the first embodiment, thumbnails of pictures are displayed in a list form in the right screen. For example, FIG. 2 illustrates an example in which thumbnails of all the pictures of which the shooting positions are in Hokkaido are displayed in a list form when Hokkaido is specified as the range.

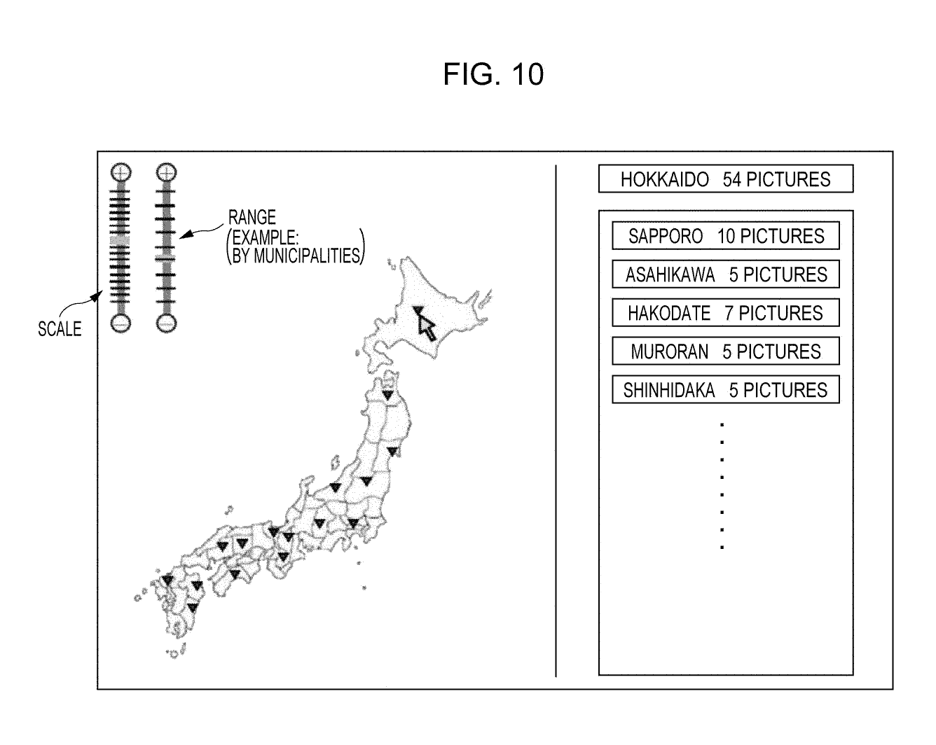

In contrast, in a second embodiment, displayed in the right screen in a list form are initially the name of the currently specified range and the number of pictures of which the shooting positions are in that range as well as the names of ranges that are lower by one level than the specified range and the number of pictures of which the shooting positions are in these ranges. Being lower by one level means the following. If the current level is a country, what is lower by one level is a region; if the current level is a region, what is lower by one level is a prefecture; if the current level is a prefecture, what is lower by one level is a municipality; if the current level is a municipality, what is lower by one level is a pinpoint spot. For example, in FIG. 10, when Hokkaido is specified as the range, displayed are the name “HOKKAIDO” and “54 PICTURES” indicating the number of pictures of which the shooting positions are in Hokkaido as well as the names “SAPPORO,” “ASAHIKAWA,” “HAKODATE,” “MURORAN,” AND “SHINHIDAKA” as the names of the ranges that are lower by one level than Hokkaido and “10 PICTURES,” “5 PICTURES,” “7 PICTURES,” “5 PICTURES,” and “5 PICTURES” indicating the numbers of pictures corresponding to the respective municipalities.

Upon any one of the ranges, or the list items, included in the list displayed in the right screen having been selected, thumbnails of the pictures of which the shooting positions are in the selected range are displayed in a list form. For example, in the example illustrated in FIG. 10, upon “SAPPORO 10 PICTURES” having been selected, thumbnails of the ten pictures of which the shooting positions are in Sapporo are displayed in a list form.

### Third Embodiment

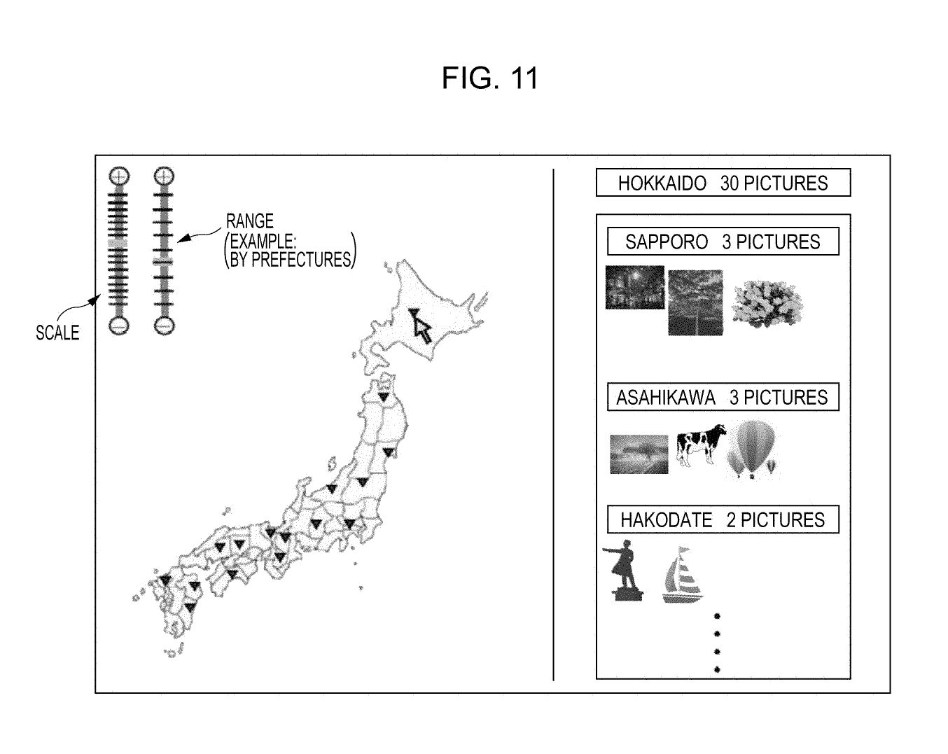

In a third embodiment, displayed in the right screen in a list form are initially the name of the currently specified range and the number of pictures of which the shooting positions are in that range as well as the names of ranges that are lower by one level than the selected range, the numbers of pictures of which the shooting positions are in these ranges, and thumbnails of these pictures. For example, in FIG. 11, when Hokkaido is specified as the range, displayed are the name “HOKKAIDO” and “54 PICTURES” indicating the number of pictures of which the shooting positions are in Hokkaido as well as the names “SAPPORO,” “ASAHIKAWA,” “HAKODATE,” “MURORAN,” AND “SHINHIDAKA” as the names of the ranges that are lower by one level than Hokkaido, “10 PICTURES,” “5 PICTURES,” “7 PICTURES,” “5 PICTURES,” and “5 PICTURES” indicating the numbers of pictures corresponding to the respective municipalities, and thumbnails of these pictures. The thumbnails of these pictures are the same as the thumbnails displayed when a range, or a list item, is selected in the second embodiment.

### Fourth Embodiment

In a fourth embodiment, the right screen is not displayed, and a map is displayed in the entire screen. Then, upon a mark ▾ displayed on the map having been selected, the name of the range corresponding to the selected mark and thumbnails of pictures of which the shooting positions are in that range may be displayed in a pop-up.

If a plurality of marks ▾ are selected, the names of the ranges corresponding to the respective marks and thumbnails of pictures of which the shooting positions are in these ranges may be displayed in a pop-up.

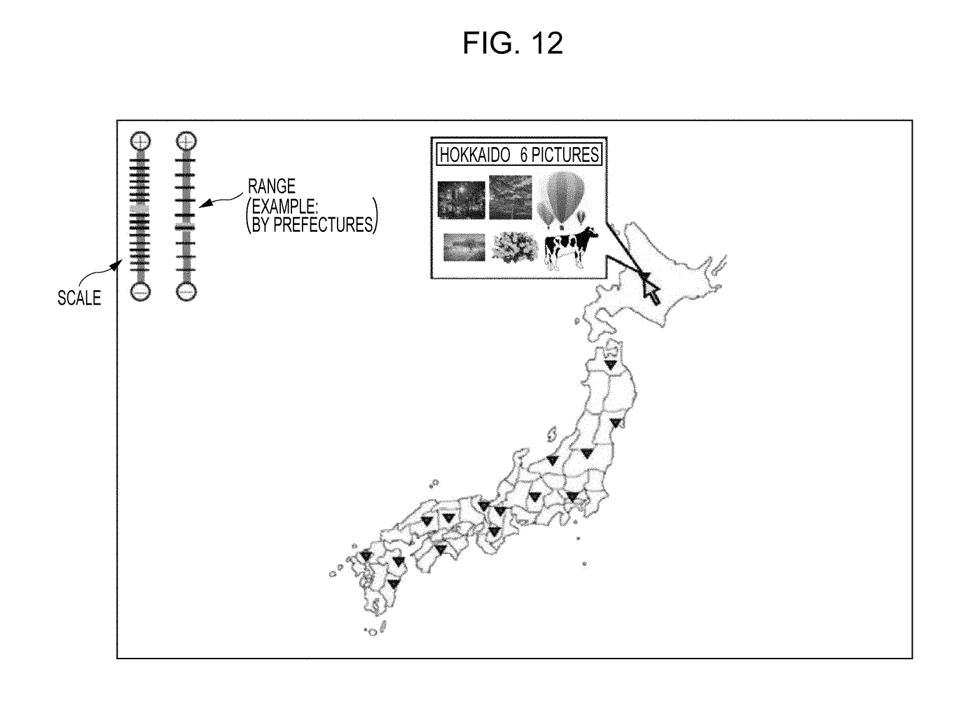

In the example illustrated in FIG. 12, the range of the display is set to the prefecture. Upon the mark ▾ corresponding to Hokkaido having been selected, the name “HOKKAIDO” and thumbnails of pictures of which the shooting positions are in Hokkaido may be displayed in a pop-up.

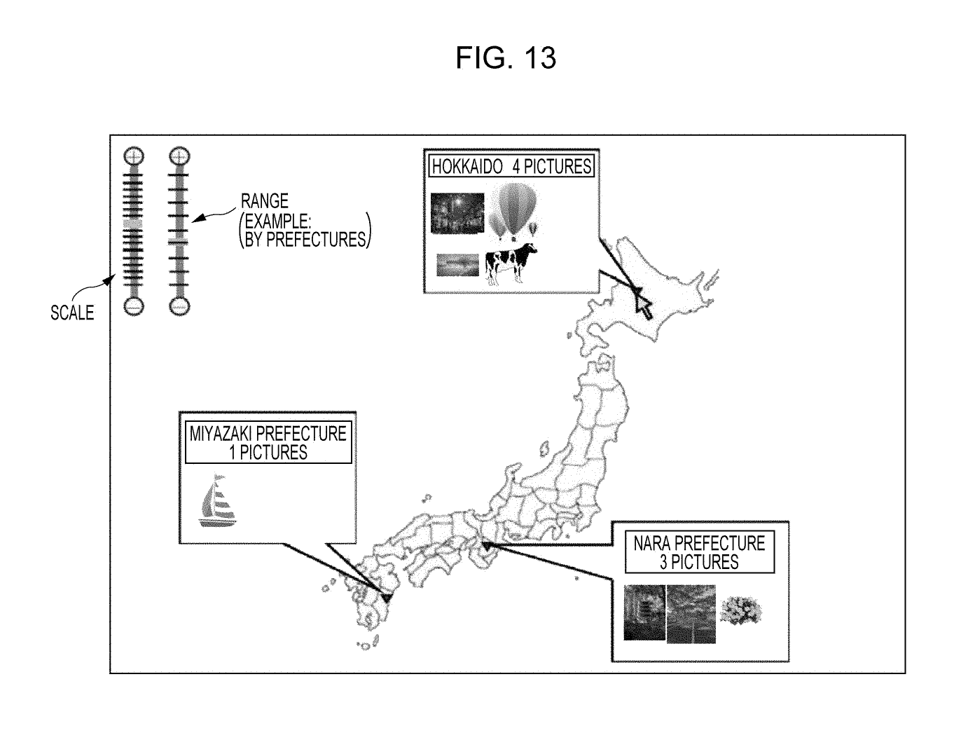

FIG. 13 illustrates an example in which three pup-up screens are displayed when the mark ▾ corresponding to Hokkaido, the mark ▾ corresponding to Nara Prefecture, and the mark ▾ corresponding to Miyazaki Prefecture have been selected.

Instead of displaying the thumbnails of all the pictures of which the shooting positions are in the selected range simultaneously in one pop-up screen, a separate pop-up screen may be displayed for each date, or a separate pop-up screen may be displayed for each of the ranges that are lower by one level than the selected range. In this case, the separate pop-up screens may be displayed simultaneously or displayed successively one by one. Furthermore, instead of displaying separate pop-up screens, separate groups may be formed and displayed in a single pop-up screen.

### Fifth Embodiment

Upon a mark ▾ corresponding to any one of the ranges having been selected in the fourth embodiment, for the range corresponding to that mark ▾, the name of that range and thumbnails of pictures of which the shooting areas are in that range are displayed in the right screen as in the first embodiment.

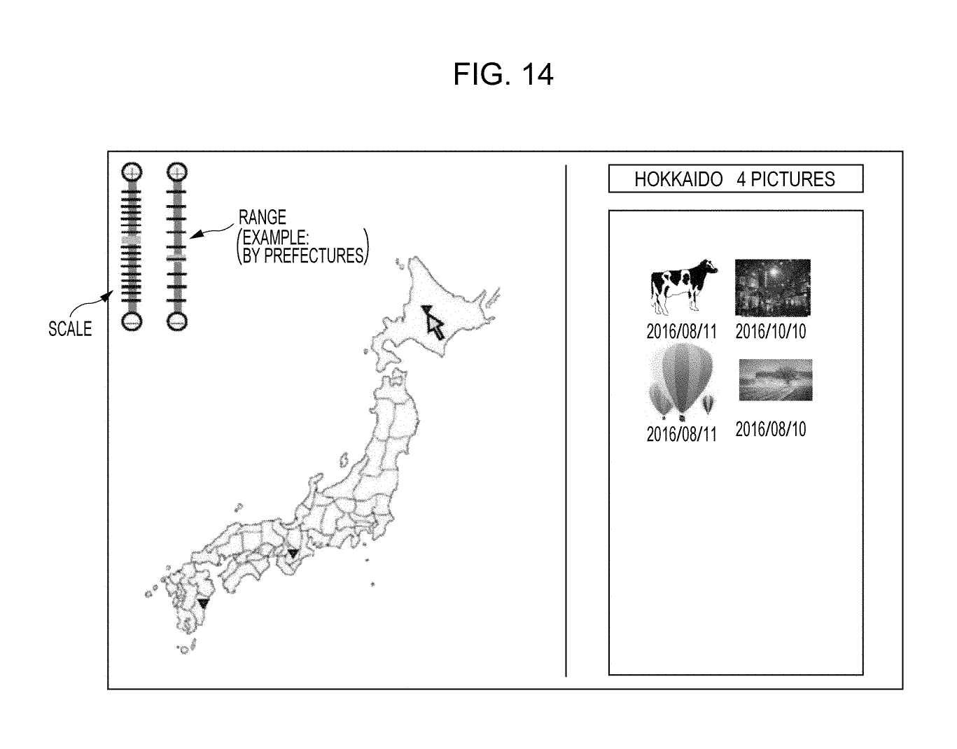

FIG. 14 illustrates a screen displayed upon Hokkaido having been selected while the year 2016 is being specified. In the right screen included in this screen, the name of the area “HOKKAIDO,” “4 PICTURES” indicating the number of pictures of which the shooting positions are in Hokkaido, and thumbnails of these pictures are displayed.

### Common Embodiment

The pictures that can be displayed in the foregoing embodiments are stored, for example, in a storage device provided inside a multifunction peripheral or stored in a storage device provided outside a multifunction peripheral that can be accessed from the multifunction peripheral, or the multifunction peripheral may be currently allowed to access only the positional information and the thumbnails of the pictures but can access the image data as well at a later time. Such pictures can be printed with an image forming apparatus included in the multifunction peripheral.

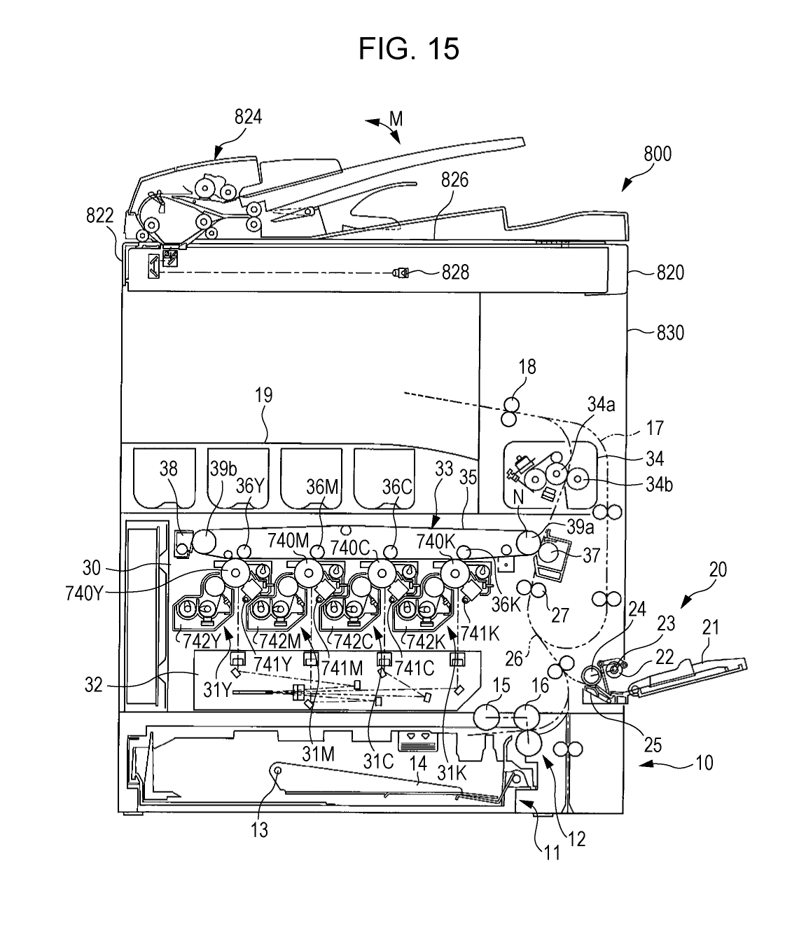

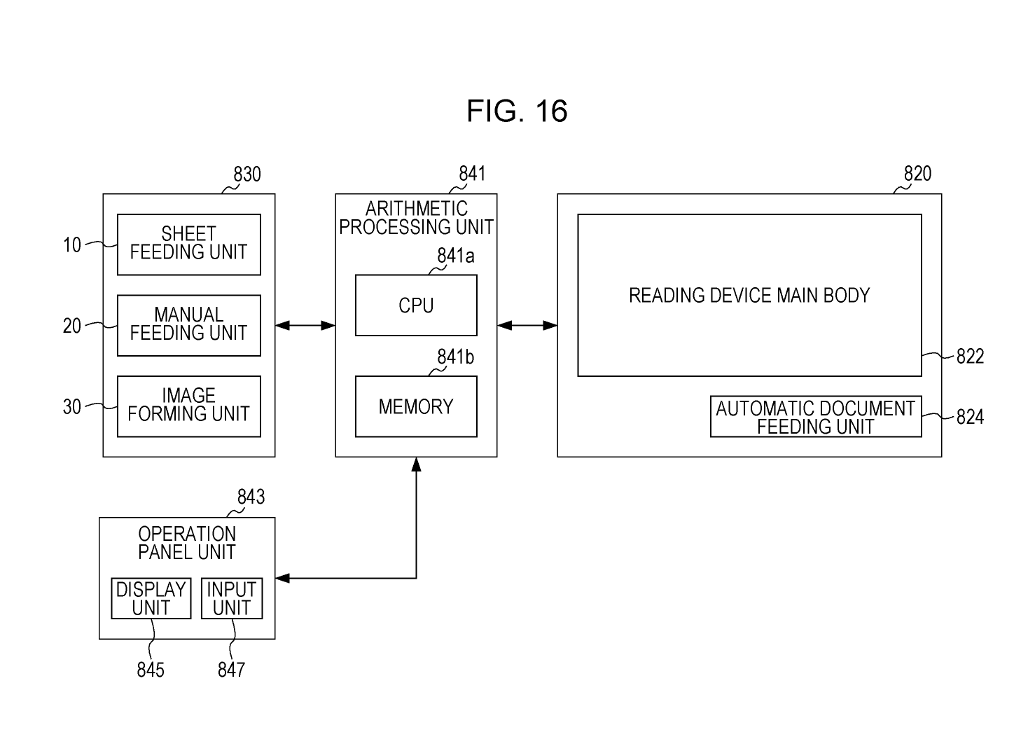

A common embodiment relates to a multifunction peripheral 800 that includes the picture-related information display device according to the first through fifth embodiments. FIG. 15 and FIG. 16 illustrate a configuration and so on of the multifunction peripheral 800.

As illustrated in FIG. 15 and FIG. 16, the multifunction peripheral 800 includes a document reading device 820 that reads an image of a document, a multifunction peripheral main body 830 (image forming unit main body) that forms an image on a sheet, an operation panel unit 843 for operating the document reading device 820 and the multifunction peripheral main body 830, and an arithmetic processing unit 841 that controls the document reading device 820 and the multifunction peripheral main body 830 in accordance with an operation of the operation panel unit 843.

The document reading device 820 can be used stand-alone to read an image, the multifunction peripheral main body 830 can be used stand-alone to form an image, and the document reading device 820 and the multifunction peripheral main body 830 can be operated together to photocopy an image. The multifunction peripheral 800 may include a storage device (not illustrated) and a facsimile device (not illustrated). The storage device can store an image read by the document reading device 820 or an image received through the facsimile device. The facsimile device can transmit an image read by the document reading device 820 or an image stored in the storage device and receive an image from the outside. Furthermore, the multifunction peripheral 800 may include an interface for connecting to a personal computer via a network. A personal computer connected to the multifunction peripheral 800 can use the functions of the multifunction peripheral for the data that the personal computer can manage.

The document reading device 820 includes an automatic document feeding unit 824 (single pass feeder (SPF)) that automatically feeds a document and a reading device main body 822 that reads an image of a document. Aside from the constituent elements illustrated in FIG. 16, the document reading device 820 includes the constituent elements illustrated in FIG. 15 that are not illustrated in FIG. 16. In addition, as illustrated in FIG. 15, the reading device main body 822 is provided with a scanner bed 826.

The multifunction peripheral main body 830 includes a sheet feeding unit 10 that feeds a sheet, a manual feeding unit 20 that allows for manual feeding of a sheet, and an image forming unit 30 that forms an image on a sheet fed by the sheet feeding unit 10 or by the manual feeding unit 20.

The sheet feeding unit 10 includes a sheet stacking unit 11 in which sheets are stacked and a separating feeding unit 12 that separates the sheets stacked in the sheet stacking unit 11 and feeds the sheets one by one. The sheet stacking unit 11 include a middle plate 14 that pivots about a rotating shaft 13, and the middle plate 14 pivots when a sheet is fed to lift up the sheet. The separating feeding unit 12 includes a pickup roller 15 that feeds the sheet lifted up by the middle plate 14 and a separation roller pair 16 that separates the sheets fed by the pickup roller 15 into individual sheets.

The manual feeding unit 20 includes a manual feed tray 21 on which a sheet can be stacked and a separating feeding unit 22 that separates the sheets stacked in the manual feed tray 21 and feeds the sheets one by one. The manual feed tray 21 is pivotally supported by the multifunction peripheral main body 830, and when a sheet is to be manually fed, fixing the manual feed tray 21 at a predetermined angle allows the sheet to be stacked on the manual feed tray 21. The separating feeding unit 22 includes a pickup roller 23 that feeds the sheet stacked on the manual feed tray 21 and a separation roller 24 and a separation pad 25 that separate the sheets fed by the pickup roller 23 into individual sheets.

The image forming unit 30 includes four process cartridges 31Y, 31M, 31C, and 31K that form, respectively, yellow (Y), magenta (M), cyan (C), and black (K) images; photosensitive drums 740Y, 740M, 740C, and 740K, which will be described later; an exposure device 32 that exposes the surfaces of the photosensitive drums 740Y to 740K; a transfer unit 33 that transfers toner images formed on the surfaces of the photosensitive drums 740Y to 740K onto a sheet; and a fixing unit 34 that fixes the transferred toner images onto the sheet. The alphabets (Y, M, C, and K) affixed at the end of the reference characters indicate the respective colors (yellow, magenta, cyan, and black).

Each of the four process cartridges 31Y to 31K can be removed from the multifunction peripheral main body 830 and is replaceable. The four process cartridges 31Y to 31K have similar configurations except that the colors of the images formed thereby differ from one another. Therefore, only the configuration of the process cartridge 31Y that forms a yellow (Y) image will be described, and the descriptions of the process cartridges 31M to 31K will be omitted.

The process cartridge 31Y includes the photosensitive drum 740Y serving as an image carrier, a charging device 741Y that charges the photosensitive drum 740Y, a developing device 742Y that develops an electrostatic latent image formed on the photosensitive drum 740Y, and a drum cleaner that removes residual toner on the surface of the photosensitive drum 740Y. The developing device 742Y includes a developing device main body (not illustrated in detail) that develops the photosensitive drum 740Y and a toner cartridge (not illustrated in detail) that supplies toner to the developing device main body. The toner cartridge can be mounted to or removed from the developing device main body. When the toner stored in the toner cartridge goes out, the toner cartridge can be removed from the developing device main body and replaced.

The exposure device 32 includes a light source (not illustrated) that emits laser light and a plurality of mirrors (not illustrated) that guide the laser light to the photosensitive drums 740Y to 740K. The transfer unit 33 includes an intermediate transfer belt 35 that carries toner images formed on the photosensitive drums 740Y to 740K, primary transfer rollers 36Y, 36M, 36C, and 36K that carry out primary transfer of the toner images formed on the photosensitive drums 740Y to 740K onto the intermediate transfer belt 35, a secondary transfer roller 37 that carries out secondary transfer of the toner images transferred to the intermediate transfer belt 35 onto a sheet, and a belt cleaner 38 that removes residual toner on the intermediate transfer belt 35. The intermediate transfer belt 35 is stretched upon a driving roller 39a and a driven roller 39b and pressed against the photosensitive drums 740Y to 740K by the primary transfer rollers 36Y to 36K. The secondary transfer roller 37 nips (pinches) the intermediate transfer belt 35 with the driving roller 39a and transfers the toner images carried on the intermediate transfer belt 35 onto a sheet at a nip portion N. The fixing unit 34 includes a heating roller 34a that heats a sheet and a pressing roller 34b that is in pressure contact with the heating roller 34a.

The operation panel unit 843 includes a display unit 845 that displays predetermined information and an input unit 847 into which the user inputs an instruction for the document reading device 820 and the multifunction peripheral main body 830. In the present embodiment, the operation panel unit 843 is disposed on the front side of the reading device main body 822. The front side corresponds to the front side of the paper plane of FIG. 15, and the rear side corresponds to the back side of FIG. 15.

As illustrated in FIG. 16, the arithmetic processing unit 841 includes a CPU 841a that drives and controls the sheet feeding unit 10, the manual feeding unit 20, the image forming unit 30, and the document reading device 820 and a memory 841b that stores various programs for operating the CPU 841a, various pieces of information to be used by the CPU 841a, and so on. The arithmetic processing unit 841 integrally controls the operations of the sheet feeding unit 10, the manual feeding unit 20, the image forming unit 30, and the document reading device 820 to form an image on a sheet in accordance with a user operation of the operation panel unit 843.

Next, an image forming operation of the multifunction peripheral 800 configured as described above (i.e., image forming control of the arithmetic processing unit 841) will be described. In the present embodiment, an image forming operation in which the image forming unit 30 forms an image of a reading document fed by the automatic document feeding unit 824 and read by the reading device main body 822 onto a sheet fed by the sheet feeding unit 10 will be described as an example.

When an image formation start signal is transmitted upon a user input into the input unit 847 of the operation panel unit 843, a reading document placed on the automatic document feeding unit 824 by the user is automatically fed toward a document reading position, and an image is read by the reading device main body 822 at the document reading position.

Upon the image of the document having been read by the reading device main body 822, the exposure device 32 irradiates the photosensitive drums 740Y to 740K with a plurality of laser light beams corresponding to the respective photosensitive drums 740Y to 740K in accordance with image information of the read document. At this point, the photosensitive drums 740Y to 740K are charged in advance by the respective charging devices 741Y to 741K, and as the photosensitive drums 740Y to 740K are irradiated with the corresponding laser light beams, electrostatic latent images are formed on the respective photosensitive drums 740Y to 740K. Thereafter, the electrostatic latent images formed on the photosensitive drums 740Y to 740K are developed by the respective developing devices 742Y to 742K, and yellow (Y), magenta (M), cyan (C), and black (K) toner images are formed on the respective photosensitive drums 740Y to 740K. The toner images of the respective colors formed on the photosensitive drums 740Y to 740K are transferred so as to be superposed on each other on the intermediate transfer belt 35 by the primary transfer rollers 36Y to 36K, and a superposed transferred toner image (a full-color toner image) is conveyed to the nip portion N while being carried on the intermediate transfer belt 35.

In parallel to the image forming operation described above, sheets stacked in the sheet stacking unit 11 are fed into a sheet conveyance path 26 by the pickup roller 15 while being separated into individual sheets by the separating feeding unit 12. Then, any oblique movement of the sheet is corrected by a registration roller pair 27 disposed upstream from the nip portion N in the sheet conveyance direction, and the sheet is conveyed to the nip portion N at a predetermined conveyance timing. The full-color toner image carried on the intermediate transfer belt 35 is transferred onto the sheet conveyed to the nip portion N by the secondary transfer roller 37.

The sheet on which the toner image has been transferred is heated and pressed by the fixing unit 34 to have the toner image molten and fixed onto the sheet, and the sheet is discharged to the outside of the device by a discharge roller pair 18. The sheet discharged to the outside of the device is stacked onto a discharged sheet stacking unit 19.

When images are to be formed on both sides (a first surface and a second surface) of a sheet, before the sheet having an image formed on the first surface is discharged to the outside of the device, the discharge roller pair 18 is rotated in reverse to convey the sheet to a double-side conveyance path 17, and the sheet is conveyed again to the image forming unit 30 through the double-side conveyance path 17. Then, in a similar manner to the first surface, an image is formed on the second surface, and the sheet is discharged to the outside of the device. The sheet discharged to the outside of the device is stacked onto the discharged sheet stacking unit 19.

The picture-related information display device described above can be implemented by hardware, software, or a combination thereof. In addition, the picture-related information display method carried out by the picture-related information display device described above can also be implemented by hardware, software, or a combination thereof. Herein, the expression “being implemented by software” means that a computer loads and executes a program to implement the above.

The program can be stored with the use of a variety of types of non-transitory computer readable media and can be supplied to a computer. The non-transitory computer readable media include a variety of types of tangible storage media. Examples of the non-transitory computer readable media include a magnetic recording medium (e.g., flexible disk, magnetic tape, and hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, and RAM (Random Access Memory)). In addition, the program may be supplied to a computer in the form of a variety of types of transitory computer readable media. Examples of the transitory computer readable media include an electric signal, an optical signal, and an electromagnetic wave. A transitory computer readable medium can provide the program to a computer via a wired communication line, such as an electric wire or an optical fiber, or via a wireless communication line.

The present disclosure can be implemented in a variety of forms without departing from the spirit or the principal features of the present disclosure. Therefore, the embodiments described above are merely examples and are not to be interpreted as limiting the present disclosure. The scope of the present disclosure is expressed by the claims and is not constrained by the descriptions in the specification in any way. Furthermore, modifications and changes that belong to the scope of equivalence to the claims are all encompassed by the scope of the present disclosure.

The present disclosure can be used to display picture-related information.

The present disclosure contains subject matter related to that disclosed in Japanese Priority Patent Application JP 2017-249338 filed in the Japan Patent Office on Dec. 26, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A picture-related information display device, comprising:
a position mark display unit that displays, on a map, a position mark corresponding to one or more pictures determined to be in a single geographical range in accordance with a predetermined standard for a positional relationship; and
a picture list display unit that, upon the position mark having been selected, displays a list of the one or more pictures corresponding to the position mark.

2. The picture-related information display device according to claim 1,
wherein the predetermined standard can be changed by a user, and
wherein, upon the predetermined standard having been changed by the user, the picture list display unit updates the list of the pictures being displayed to a list of pictures determined to be in a single geographical range updated by the change.

3. The picture-related information display device according to claim 1,
wherein the position mark display unit displays, on the map, the position mark corresponding to the one or more pictures determined to be in the single geographical range in accordance with the predetermined standard for the positional relationship for each of a plurality of single geographical ranges.

4. The picture-related information display device according to claim 3,
wherein, upon a plurality of the position marks having been selected, the picture list display unit displays the list of the one or more pictures corresponding to each of the plurality of position marks.

5. The picture-related information display device according to claim 1,
wherein, upon the position mark having been selected and upon a temporal range having been specified, the picture list display unit displays a list of pictures of which a shooting date and time falls within the temporal range among the one or more pictures corresponding to the position mark.

6. The picture-related information display device according to claim 1, further comprising:
a single picture display unit that, upon any one of the pictures included in the list of the pictures having been selected, displays the selected picture in a size larger than the size held when being displayed in a list along with additional information.

7. The picture-related information display device according to claim 1,
wherein, upon any one of the pictures in the list of the pictures having been selected, the position mark indicating a range to which a shooting position of the selected picture belongs among a plurality of ranges lower by one level than the single geographical range is highlighted.

8. A picture-related information display device, comprising:
a position mark display unit that displays, on a map, a position mark corresponding to one or more pictures determined to be in a single geographical range in accordance with a predetermined standard for a positional relationship; and
a number list display unit that, upon the position mark having been selected, displays a name of each geographical range of a plurality of geographical ranges that are lower by one level than the geographical range corresponding to the position mark and the number of pictures of which shooting spots are in the geographical range.

9. The picture-related information display device according to claim 8, further comprising:
a picture list display unit that, upon a display area of either of the name of the geographical range and the number of the pictures of which the shooting spots are in the geographical range displayed by the number list display unit having been selected, displays the name of each geographical range of a plurality of geographical ranges that are lower by one level than the geographical range corresponding to the selected display area and the number of the pictures of which the shooting spots are in the geographical range.

10. The picture-related information display device according to claim 8, further comprising:
a pop-up screen display unit that, upon a display area of either of the name of the geographical range and the number of the pictures of which the shooting spots are in the geographical range displayed by the number list display unit having been selected, displays a pop-up screen that includes the name of the geographical range corresponding to the selected display area and the number and images of one or more pictures of which the shooting spots are in the geographical range.

11. The picture-related information display device according to claim 10, further comprising:
a pop-up screen display unit that, upon a plurality of display areas of either of the name of the geographical range and the number of the pictures of which the shooting spots are in the geographical range displayed by the number list display unit having been selected, displays a pop-up screen that includes the name of the geographical range corresponding to each of the selected plurality of display areas and the number and images of one or more pictures of which the shooting spots are in the geographical range.

12. The picture-related information display device according to claim 8, further comprising:
a picture list display unit that, upon a display area of either of the name of the geographical range and the number of the pictures of which the shooting spots are in the geographical range displayed by the number list display unit having been selected, displays the name of the geographical range corresponding to the selected display area, the number of pictures of which the shooting spots are in the geographical range, and a list of the pictures.

13. The picture-related information display device according to claim 1,
wherein a scale of the map can be changed by the user.

14. A multifunction peripheral, comprising:
the picture-related information display device according to claim 1.

15. A program that causes a computer to function as the picture-related information display device according to claim 1.

16. A picture-related information display method, comprising:
displaying, on a map, a position mark corresponding to one or more pictures determined to be in a single geographical range in accordance with a predetermined standard for a positional relationship; and
displaying, upon the position mark having been selected, a list of the one or more pictures corresponding to the position mark.
